(19) United States
(12) Patent Application Publication
(10) Pub. No.: US 2006/0234128 A1
(43) Pub. Date: Oct. 19, 2006

(54) Fabricating method of lithium polymer cell

(76) Inventor: Yu-Ta Tu, Hsinchu-Hsien (TW)

Correspondence Address: PRO-TECTOR INTERNATIONAL SERVICES, 20775 NORADA CT., SARATOGA, CA, 95070, US

(21) Appl. No.: 11/187,641

(22) Filed: Jul. 21, 2005

(30) Foreign Application Priority Data
Apr. 13, 2005 (TW) 094111602

(51) Int. Cl. H01M 2/16; H01M 4/58; H01M 4/62

(52) U.S. Cl. 429/254; 429/231.95; 429/232

(57) ABSTRACT

A lithium polymer cell comprises a positive electrode plate, a separator membrane, a negative electrode plate a separator membrane; and a positive electrode plate which are sequentially arranged, or a negative electrode plate, a separator membrane, a positive electrode plate a separator membrane; and a negative electrode plate which are sequentially arranged. The positive electrode plate includes the mixture of adhesives, conductive carbon, activating substance with suitable amounts of solvent Acetone and N-methyl-2-pyrrolidone. The negative electrode plate includes the mixture of adhesives, conductive carbon, activating substance with suitable amounts of solvent Acetone and NMP; and the separator membrane includes the mixture of adhesives, filler and a predetermined amount of solvent.

### FIELD OF THE INVENTION

The present invention is mainly related to a fabricating method of a positive-negative electrode adhesive-type Lithium polymer cell, wherein it simplified the fabricating procedure via the betterment of the separator membrane.

### BACKGROUND OF THE INVENTION

There requires large amounts of more continent, higher performance and lower cost secondary cells with fast development of various portable electronic product such as cellular phone, note book computer, personal digital assistance (PDA), etc. Lithium polymer most conforms to the above-mentioned requirements among the current all secondary cells since it has the advantage of high energy density, long circulation times, high operation voltage, long storage life, as well as having the degree of safety upon using said cells.

At prior art research, there discloses in U.S. Pat. No. 5,540,741 that utilizes poly vinylidene fluoride and hexa fluoropropylene as the binding agent, besides, they add di-butyl phthalate (DBP) as the plasticizers for film-formation of the slurry of positive and negative electrode and the film-formation of films such that the polar plate of positive and negative charge and the films could be separated from the substrate after coating, which also let said rear end electrode material could be heat-pressing processing engineering toward the electrode separator membrane & the electronic-collecting net. After they were unified into bicell, it extracts DBP out via utilizing the solvents such as methanol so that there having a purity of pore structure for electrode plate and separator membrane.

The advantage of the above-mentioned fabricating method is mainly on the introduction of plasticizer, which let the electrode material having fine degree of plasticity after coating and thus it could combines the electronic collector, the plate material and the separator membrane, after the plasticizers to be taken out, it could also having the effect of pore-forming, which forms the electrolyte conduct. Besides, since the positive and negative electrode are combined tightly through the separator membrane, the joint is uneasily to form the void which interferes with the ion transport, so there also gets rid of the requirement of tightly pressing the electrode of the outer package such that the cells could be fabricated lighter and thinner. However, since it took too long to take out DBP, which consumes large amounts of extract solvent, it is easily to be left, which influences the performance of cells. That's its drawback.

Thus, the inventor considers it necessary to better the fabrication method of positive and negative electrode Lithium polymer cells.

### SUMMARY OF THE INVENTION

The object of the present invention, however, is to provide a novel fabricating method and technology of the electrode adhesive typed polymer cells which betters the drawback of the above-mentioned fabrication method of Lithium polymer cells; besides, it is easily to be processing and fabricated under the advantage of conservation the advantage of electrode adhesion, which also elevates the performance of the cells. The major character of the present invention is to utilize the separator membrane slurry developed via the present invention, after the solvent is evaporated, there forms a slurry gel type which is easily to be adhesive on the surface after the solvent is evaporated, wherein said recipe does not uses plasticizers such as DBP, so that the cell do not have to proceed the time-consuming extract procedure after adhesion. Wherein the betterment character comprises:

(1) shorten fabrication time

(2) with higher degree of safety for the cells

(3) with higher energy density for the cells

(4) with fine cycle lifetime for the cells

(5) With relatively low resist inside said cells, also it is stable.

(6) With better large current charge-and-discharge character.

(7) More environmental protection during the fabrication process.

### BRIEF DESCRIPTION OF THE DRAWINGS

FIG. 1 shows the flowchart of the fabrication method of the Lithium polymer cell of the present invention.

### DETAILED DESCRIPTION OF THE PREFERRED EMBODIMENTS

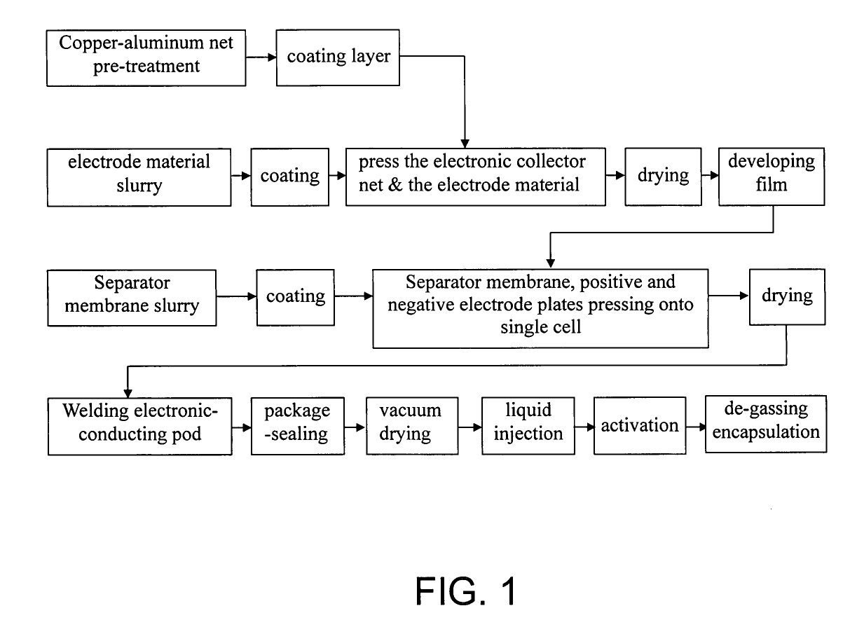

The present invention emphasizes to fabricate the positive and negative charge adhesive typed Lithium polymer cells under the condition of plasticizers, wherein said method of embodiment, as illustrated in FIG. 1, comprises:

Step 1: Preparing an adhesive and plastic positive electrode film, which is mainly to mix the active substance, the conductive carbon, the adhesive and the solvents gently via utilizing the slurry-mixing procedure and spray to coat and drying and a positive electrode film is formed;

Step2: Preparing an adhesive and plastic negative electrode film, which is mainly to mix the active substance, the conductive carbon, the adhesive and the solvents gently via utilizing the slurry-mixing procedure and spray to coat and drying and a negative electrode film is formed;

Step3: Preparing an adhesive and plastic separator membrane, which is mainly to mix the inorganic filler, the adhesive and the solvents gently via utilizing the slurry-mixing procedure and spray to coat and drying and an separator membrane is formed;

Step 4: Preparing a negative electrode electric-conductor with fine degree of adhesive and fine degree of electric-conductivity, which is mainly to utilize the copper net or the copper foil, after they were soaped through the dilute sulfuric acid, they were washed via the pure water, next to coat the conductive carbon, the adhesives and the solvent mixing gently, after hot wind drying, there formed negative electric conductor with adhesive layer;

Step5: Preparing a positive electrode electric-conductor with fine degree of adhesive and fine degree of electric-conductivity, which is mainly to utilize the aluminum net or the aluminum foil, after they were soaped through the dilute NaOH solution, they were washed via the pure water, next to coat the conductive carbon, the adhesives and the solvent mixing gently, after hot wind drying, there formed positive electric conductor with adhesive layer;

Step6: Preparing a positive electrode, which is formed by pasting the prior positive electrode film and positive electric-collector and heating and pressing and next hot wind drying;

Step 7: Preparing a negative electrode, which is formed by pasting the prior negative electrode film and negative electric-collector and heating and pressing and next hot wind drying;

Step 8: Preparing an bicell structure, which is mainly by cutting the prior made positive electrode and negative electrode plate and the separator membrane to a certain size, and next they were stacked via the sequence of Positive electrode plate-separator membrane—Negative electrode plate—separator membrane—Positive electrode plate or Negative electrode plate-separator membrane—Positive electrode plate—separator membrane—Negative electrode plate, and heating and pressing and hot wind drying;

Step 9: Taking adequate above-mentioned bicell structure in accordance with the requirement of cell design capacity, and weld the positive, negative electrode electrode-conducting pod, next they were placed inside the Aluminum foil bag, after vacuum drying to get rid of water, pouring into the electrolyte and precede cell activation.

Among the above-mentioned process, said

(a) Separator Membrane

Said separator membrane is to mix the adhesives such as poly vinylidene fluoride 20-80 wt %, filler (SiO₂, TiO₂, Al₂O₃ . . . ) 20-80% in addition to suitable amounts of solvent (acetone, NMP) with the ball-grinding machine for 5 hours to fabricate the required separator membrane slurry. The way of film-formation could be fabricated via taking-off after the solvents to be coated onto the film-forming substrates evaporates or it adopts another porous polymer film to coats on the surface of the backbone of PP, PE, which forms the complex separator membrane.

(b) Positive Electrode

Proceeds slurry mixing via adding the adhesives, conductive carbon, activating substance with suitable amounts of solvent Acetone and NMP, (N-methyl-2-pyrrolidone) which mixes completely for five hours with ball-grinding machine to fabricate the required positive electrode slurry, wherein said adhesive is poly vinylidene fluoride, which is 2-15%, the conductive carbon such as carbon black is 2-10 wt %, the Lithium compound of active substance LiCoO₂, LiNiO₂, LiMn₂O₄, LiNixCo1-xO₂ is 75-96 wt %. Wherein said electrode conductor could be Aluminum foil or Aluminum net, coat said slurry onto the Aluminum foil or net with the coating machine, after drying it cuts onto the required size, which completes the fabrication of positive electrode. When using the Aluminum net as the electronics-collector, it is also practicable to coat said positive electrode slurry onto one coating substance, after drying it pastes the electronics-net and the electrode material film with hot pressing method, after drying it cuts onto the required size.

(c) Negative Electrode

Proceeds slurry mixing via adding the adhesives, conductive carbon, activating substance with suitable amounts of solvent Acetone and NMP, which mixes completely for five hours with ball-grinding machine to fabricate the required negative electrode slurry, wherein said adhesive is poly vinylidene fluoride, which is 2-15%, the conductive carbon such as carbon black is 2-10 wt %, the active substance such as the mesocarbon microbeads, nature graphite as well as its refinement, other carbon material, tin compound, silicide is 75-96 wt %. Wherein said electrode conductor could be copper foil or copper net, coat said slurry onto the copper foil or net with the coating machine, after drying it cuts onto the required size, which completes the fabrication of negative electrode. When using the copper net as the electronics-collector, it is also practicable to coat said negative electrode slurry onto one coating substance, after drying it pastes the electronics-net and the electrode material film with hot pressing method, after drying it cuts onto the required size.

Put it into practice in accordance with the above-mentioned fabrication method, for example:

### EXAMPLE 1

Separator membrane—takes poly vinylidene fluoride 70 wt %, SiO2 30 wt % in addition to suitable amounts of acetone, NMP. Mix for five hours with ball grinding machine completely to fabricate the required separator membrane slurry. Using the PP porous film as the backbone, which coats suitable amounts of slurry on its surface to form the composite typed separator membrane?

Positive electrode—take carbon black 6 wt %, poly vinylidene fluoride 9 wt %, LiCoO₂ 85 wt %, suitable amounts of acetone and NMP. Mix thoroughly with the ball-grinding machine completely to fabricate the required positive electrode slurry. Coats said slurry onto one substance, taking it off after evaporates. Adhere the electron-collecting net and the electrode material film with hot pressing method, next cut to the required size.

Negative electrode—take carbon black 4 wt %, poly vinylidene fluoride 11 wt %, mesocarbon microbeads 85 wt %, suitable amounts of acetone and NMP. Mix thoroughly with the ball-grinding machine completely to fabricate the required negative electrode slurry. Coats said slurry onto one substance, taking it off after evaporates. Adhere the electron-collecting net and the electrode material film with hot pressing method, next cut to the required size.

Combines the positive electrode, negative electrode and the separator membrane with hot pressing, after 30 minutes of hot wind drying continue the further liquid injection as well as encapsulation.

### EXAMPLE 2

The positive electrode, negative electrode the same as the example 1 mentioned fabricating procedure, wherein the separator membrane is to add poly vinylidene fluoride 70 wt %, SiO₂ 30 wt % in addition to suitable amounts of acetone, NMP. Mix thoroughly with the ball-grinding machine 5 hours completely to fabricate the required separator membrane slurry, next it coats said slurry onto one substance, taking it off after evaporates, and acquire one gel type thin film. Combines the positive electrode, negative electrode and the separator membrane with hot pressing, after room temperature 12 hours continue the further electrolyte injection as well as encapsulation.

Test said 600 mAH Lithium polymer cell fabricated by example one, and acquire each character of table 1.

TABLE 1

| | Cell fabricated via the present |
|---|---|
| Item | invention |
| 0.5 C charge and discharge efficiency (%) | 98-99 |
| Internal resistance (mΩ) | 45-55 |
| Cell lifetime (%) | 95.2 |
| (0.5 C charge and discharge 100 times) | |
| Rate of self discharge (28 days) (%) | 92.4 |

As shown in table one, from the character commonly used by the cells such as: 0.5 C charge and discharge efficiency, internal resistance, cell life time for 0.5 C charge and discharge 100 times, as well as 28 days self discharge rate we could see: the present invention could acquire the Lithium polymer cell with excellent cell character, fine workability, low cost as well as environmental-protection.

The present invention has been illustrated as the above-mentioned examples, which should be understood that it is descriptive rather than limited. Those who are familiar with such skills could be made modification in accordance with the above-mentioned description, which may made any changes or modifications. Thus, the scope of the present invention is limited within the Claim.

1-13. (canceled)

14. A lithium polymer cell, comprising:
a positive electrode plate, a separator membrane, a negative electrode plate, a separator membrane and a positive electrode plate which are sequentially arranged;
wherein the positive electrode plate includes the mixture of adhesives, conductive carbon, activating substance and two kinds of solvents;
the negative electrode plate includes the mixture of adhesives, conductive carbon, activating substance and two kinds of solvents; and
the separator membrane includes the mixture of adhesives, filler and two kinds of solvents;
wherein the two kinds of solvents which have different boiling points; when one of the solvents evaporates, the separator membrane still have another solvent so that the separator membrane has a form of gel, and thus the separator membrane can be adhered to the negative electrode plate and positive electrode plate; and each of the mixtures of the negative electrode plate and positive electrode plate contain at least one solvent, when one of the solvent evaporates, another solvent can retain the flexibility of the electrodes.

15. The lithium polymer cell as claimed in claim 14, wherein the two kinds of solvents of the positive electrode plate and negative electrode plate and separator membrane are acetone and N-methyl-2-pyrrolidone.

16. The lithium polymer cell as claimed in claim 14, wherein in the positive electrode plate, the content of the adhesive is poly vinylidene fluoride of 2-15 wt %, the content of the conductive carbon is carbon black of 2-10 wt %, the content of the lithium compound of active substance is one of LiCoO₂, LiNiO₂, LiMn₂O₄, LiNixCo1-xO₂ with a weight percentage of 75-96 wt %.

17. The lithium polymer cell as claimed in claim 14, wherein in the negative plate, the content of the adhesive is poly vinylidene fluoride of 2-15 wt %, the content of the conductive carbon is carbon black with a content of 2-10 wt %, the content of the active substance is one of mesocarbon microbeads, nature graphite and the refinement thereof, and other carbon material, tin compound, and silicide with a content of 75-96 wt %.

18. The lithium polymer cell as claimed in claim 14, wherein the separator membrane, the content of the adhesive is poly vinylidene fluoride of 20-80 wt %, the content of the filler is one of SiO₂, TiO₂, and Al₂O₃ of 20-80%.

19. The lithium polymer cell as claimed in claim 14, wherein the separator membrane utilizes the poly propylene or poly ethylene porous film as the backbone, there coats the composite typed separator membrane containing adhesive as well as the composite separator membrane with filler.

20. A lithium polymer cell, comprising:
a negative electrode plate, a separator membrane, a positive electrode plate, a separator membrane and a negative electrode plate which are sequentially arranged;
wherein the positive electrode plate includes the mixture of adhesives, conductive carbon, activating substance and two kinds of solvents;
the negative electrode plate includes the mixture of adhesives, conductive carbon, activating substance and two kinds of solvents; and
the separator membrane includes the mixture of adhesives, filler and two kinds of solvents;
wherein the two kinds of solvents which have different boiling points; when one of the solvents evaporates, the separator membrane still have another solvent so that the separator membrane has a form of gel, and thus the separator membrane can be adhered to the negative electrode plate and positive electrode plate; and each of the mixtures of the negative electrode plate and positive electrode plate contain at least one solvent, when one of the solvent evaporates, another solvent can retain the flexibility of the electrodes.

21. The lithium polymer cell as claimed in claim 20, wherein the two kinds of solvents of the positive electrode plate and negative electrode plate avid separator membrane are acetone and N-methyl-2-pyrrolidone.

22. The lithium polymer cell as claimed in claim 20, wherein in the positive electrode plate, the content of the adhesive is poly vinylidene fluoride of 2-15 wt %, the content of the conductive carbon is carbon black of 2-10 wt %, the content of the lithium compound of active substance is one of LiCoO₂, LiNiO₂, LiMn₂O₄, LiNixCo1-xO₂ with a weight percentage of 75-96 wt %.

23. The lithium polymer cell as claimed in claim 20, wherein in the negative plate, the content of the adhesive is poly vinylidene fluoride of 2-15 wt %, the content of the conductive carbon is carbon black with a content of 2-10 wt %, the content of the active substance is one of mesocarbon microbeads, nature graphite and the refinement thereof, and other carbon material, tin compound, and silicide with a content of 75-96 wt %.

24. The lithium polymer cell as claimed in claim 20, wherein the separator membrane, the content of the adhesive is poly vinylidene fluoride of 20-80 wt %, the content of the filler is one of SiO₂, TiO₂, and Al₂O₃ of 20-80%.

25. The lithium polymer cell as claimed in claim 20, wherein the separator membrane utilizes the poly propylene or poly ethylene porous film as the backbone, there coats the composite typed separator membrane containing adhesive as well as the composite separator membrane with filler.
